(19) United States
(12) Patent Application Publication
(10) Pub. No.: US 2023/0283204 A1
(43) Pub. Date: Sep. 7, 2023

(54) INCHWORM ACTUATOR

(71) Applicant: ALEXANDER Sergeev, SAN FRANCISCO, CA (US)

(72) Inventor: ALEXANDER Sergeev, SAN FRANCISCO, CA (US)

(21) Appl. No.: 17/687,616

(22) Filed: Mar. 5, 2022

(51) Int. Cl. H02N 2/02

(52) U.S. Cl. CPC H02N 2/023

(57) ABSTRACT

An inchworm actuator particularly adapted to implementation of robotic muscles through loosening and tightening of tendon-like structures, including a piezoelectric stack which expands and contracts the actuator, and one or more paired sets of clamps which are engaged and disengaged by means of piezoelectric stacks. Some embodiments are IM2R, which manipulate non-looped tendons, and IM2B, which manipulate looped tendons in a ‘bridgelike’ structure.

### CO-PENDING PATENT APPLICATIONS

This Nonprovisional Patent Application is a Continuation Application to U.S. Nonprovisional Patent Application Ser. No. 63/158,859 as filed on Mar. 9, 2022 by Inventor Alexander Sergeev and titled INCHWORM ACTUATOR. Said U.S. Nonprovisional Patent Application Ser. 63/158,859 is incorporated in its entirety and for all purposes into this Nonprovisional Patent Application.

### FIELD OF THE INVENTION

The field of the invention relates generally to actuators, and specifically to a pulling actuator design suitable for application analogous to a tendon muscle.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Generally speaking, anywhere there is powered movement by a machine, there's an actuator that translates an energy source into physical motion, such as a motor that spins a shaft (a rotary actuator) or one that pushes or pulls on whatever may be attached (a linear actuator). The variety of mechanical actuators and motors known in the art of engineering allows for wide ranges of application already, and often allows an engineer to select, not just an actuator that is capable of a given task, but a variety of actuator that can accomplish the desired motion most efficiently and with the least additional engineering.

However, the field of robotics, particularly applications that are useful as everyday applications instead of scientific curiosities, is strictly limited by what can be done efficiently and cheaply with actuators as currently known in the art; namely, what movements actuator designs already known in the art happen to be ‘good at’. As a practical example: household robots that can do vacuuming and mopping are already in widespread use; why not one that can fold laundry? What makes the latter so much more difficult to provide with the same accessibility to ordinary consumers? One key reason for this is because implementing motor-driven wheels, such as on most vacuuming or mopping robots, is relatively easy and can be done with comparatively few actuators, while limbs dexterous enough to just pick up and fold a shirt, as most humans would do with ease, could require dozens or hundreds of those same or similar actuators, painstakingly designed and installed to work in concert. While still possible, utility and accessibility of this type of robotic application is limited at least because all of those extra actuators drive up production cost and expense, and uses resources inefficiently. Innovation in the art of robotics is decisively limited by which motions and actions current models of actuators as already known in the art happen to be ‘good at’. Prosthetic limbs exist, but aren't as affordable, practical, or seamless as they could be, due to this same kind of limitation.

Therefore, there is a long-felt need in the art of engineering and robotics to provide and make available further novel actuator implementations adapted to excel at different varieties of powered motion.

### SUMMARY OF THE INVENTION

Towards these and other objects of the method of the present invention (hereinafter, “the invented method”) that are made obvious to one of ordinary skill in the art in light of the present disclosure, what is provided is a novel variety of inchworm actuator.

Inchworm actuators in general are a variety of “pulling” actuator that uses piezoelectric, electrostatic, magnetostriction, or similar motors to move a shaft with nanometer precision. The piezoelectric motors are activated in sequence to grip, extend, un-grip, and contract such that the shaft is moved along by an incremental ‘inching’ movement. The traditional view is that inchworm actuators excel at precision motions, able to measure the ‘inching’ motions down to the nanometer and start or stop very precisely. As generally known in the art, an inchworm actuator is fixed to a given spot and pulls on the shaft to change the position of the shaft relative to the fixed position of the actuator.

In preferred embodiments, the invented inchworm actuator is distinct in a few ways, and the system in which this invented inchworm actuator is applied is counterintuitive to inchworm actuators as known in the art. For one, while most actuators would generally be mounted onto a single physical point of the machine being operated, such as with bolts or welding, the use of inchworm actuators in combination with tendonlike structures may allow the weight of the actuator to be supported entirely by the tension of the tendon, with no mounting of the actuator actually necessary. This may provide unprecedented flexibility of design, both in expansion of what can be designed and in the movement capabilities of the resulting machines.

There are many varieties of inchworm actuators which already exist in the art, and what these generally have in common is the motion cycle of ‘grip, extend, shift grip, contract’. A key distinction made possible in the present invention pertains to the specific operation of the clamp elements, and the specifics of the device's motion (sequence to grip, extend, un-grip, and contract). Specifically, the position of the actuator itself may not change between cycles, and instead the actuator may move one or two loops of tendons. Embodiments with two clamps for moving a single tendon, four clamps for moving two tendons at once, or other embodiments are all within the scope of the present invention. Implementation of a pair of loops also makes the speed of closing to ends twice as fast, because two tendons are moving during the same cycle. Further, the invented actuator may not actually be mounted, such as by being bolted down, and may instead be suspended on or between the tendons which the actuator operates, such that the actuator manipulates the tendons by modifying the position of the actuator upon the tendons.

As a practical illustration, one might consider a person standing on a platform suspended between two ropes or loops of rope. If the person pulls on their left-hand rope, the platform swings leftward; the distance between the platform and whatever may be anchoring the rope on the left-hand side is reduced, and the tension on the left-hand rope is increased. Meanwhile, the right-hand rope is pulled along, and so also is under a different amount of tension than before. The person on the platform pulling the ropes manipulates the tension of the ropes by manipulating their own position relative to the ropes. This is analogous to the preferred application of the invented actuator positioned to inchworm-move along two loops of tendon, thus loosening and tightening the tendons.

As an example of this kind of system's value in an application such as robotic muscles, one might consider the similarity in design to biological muscles. In the human body, muscles produce force and motion by contracting and releasing, and in doing so pull on tendons, which connect muscles to bones and can be put under tension like a rubber band. One's fingers don't need much on-site muscle of their own (think how bulky that would be!) because muscles in the palm and forearm provide the power, pulling on tendons connected to the finger bones. Now, consider that the invented actuator provides force to effect motion by expanding and contracting to put tension on a stretchable tendon (which, in this case, might actually be a rubber band). For a large limb, bigger tendons or more tendon systems operating in parallel may be needed, but the basic concept is the same for a knee, an elbow, a facial muscle, or a finger.

Assembling the tendon structures as loops pulled by inchworm actuators is particularly valuable and relevant to assembling of novel forms of robot locomotion. In the case that the actuator is attached to two different tendon loops, this lightweight actuator need not be anchored or ‘bolted down’ to a fixed point on the robot, because the actuator can be physically supported by the tension in the tendons to which the actuator is coupled, which could in many applications be mounted using something as simple as a hook or two. Further, this kind of application lends itself to placing and operating actuators in parallel or sequentially, each of these options providing capacity to multiply the generated force.

In various embodiments of the invention, the tendon component may be flexible or a greater or lesser degree, such as a cord, stretchy band, wire, or thin metal or plastic rod, as several non- limiting examples. Tendons as understood herein need not resemble anatomical tendons; the concept inspiring this terminology is that of a structure that allows a muscle to pull on something located distantly, rather than requiring muscles to be positioned directly at a site of motion. For instance, the majority of muscles used for moving one's fingers are located in one's forearms, not in the fingers themselves; tendons connect these muscles to the bones of the fingers and allow those forearm muscles to effect finger motion. It is noted, regarding more sophisticated musculature in the field of robotics, that if one wants to mimic motion found in nature (such as that of a human hand, limb, or face), one might benefit from following the corresponding naturally-occurring engineering examples, instead of trying to approximate the same effect using the same motors one might use to turn wheels.

It is noted that, while manipulation of tendon-like structures is the primary application described herein, other applications of this new variety of actuator may quickly become apparent, including at least robotic facial muscles and skin, and new varieties of locomotion such as propellers, wheels, legs, hoses, hands, fins, and sails.

It is understood that the invented components are scalable, and indeed, benefits include the possibility of making very small functional embodiments utilizing the same principles. Any sizes or measurements included in this disclosure should be viewed as presenting of functional examples, rather than construed as limitations.

Further, while visual representations herein present components such as clamps as having certain shape or structure, it is understood that these may vary broadly. One skilled in the art will recognize that there are many shapes of clamp available that would be suitable but are not presented herein, and that the art may further innovate to construct a clamping mechanism ideal for this purpose. One notes that, while inchworm actuators use clamping to effect motion, the means of clamping does not ‘matter’ to the actuator as long as the clamp works.

It is noted that the invented device and elements of the invented device can be constructed several ways, and these may easily vary in materials used, as considered feasible and acceptable in the art of manufacture. Some non-limiting examples of such materials may include plastic such as molded plastic or 3D-printed material; metal such as laser-cut sheet metal or molded or welded components, metal, piezoceramic or other materials can be placed via direct deposition as a spray or as material soluble in liquid; wood; glass; rubber; ceramic; or other suitable materials as known in the art. It is noted that some components may require electrical conductivity or semi-conductivity, and that this may influence which materials are appropriate. Further, while the invented device can be built as very lightweight, and this quality may be particularly useful in certain applications, this should not be construed as a limitation.

Multiple varieties of invented inchworm actuator are presented herein, and a distinction is made between IM1 and IM2 (an inchworm actuator coupled with a single tendon as opposed to two tendons at once) and also between IM2R and IM2B; both of these are inchworm actuators coupled to two tendons, but the former's tendons are regular, while the latter's tendons are bridgelike. The structural difference between a regular tendon and a bridgelike tendon is generally whether the actuator is operating on single lengths of tendon or on loops. The IM2B bridgelike variation (loops) is considered to be steadier and more well-balanced, but also more expensive and complex. IM2B's may have up to 400% to 500% contraction rate and generate the force up to 200N (lifting 20 kg or 45 lbs.). The IM2B embodiment are believed to be the most promising for application to robotics.

Further benefits of the invented inchworm actuators in general, and IM2B's in particular, are believed to include some or all of the following. (1.) Fast contraction, wherein the frequency of performing each step may be 20 kHz and with step=0.1 mm it may be 2 m/sec. (2.) Strong contraction. The reachable force for every actuator may be 200 N (lifting 20 kg). But actuators may also be unified in parallel or sequentially. For example, 100 actuators will provide lift up to 2000 kg. For comparison, human bicep may lift 80 kg. (3.) Small size. The size is approximately 20mm*10mm*10mm. (4.) Low cost. (5.) No tuning needed. There is no need to tune an actuator after assembling. (6.) Long duration. Depending on materials, the actuator may perform controlled actuation without stop for 1-2 years. (7.) High efficiency—no parasite induction or hit losses, i.e. better than electromagnetic motors. (8.) Easy mounting—IM2B means no screws or other things. The actuators is mounting by putting one loop to a hook and putting another loop to another hook. Plus plugging the electricity. (9.) Self-tuning. IM2B is self-tuning by choosing the right degree of tense. (10.) Precise actuation—the actuation process contains of small multiple steps performing with high frequency. This allows to make precise and fast actuation. (11.) Lightweight—an actuator contains small amount of metal and plastic or metal tendons. It is much lighter than electric motors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### INCORPORATION BY REFERENCE

All publications, patents, and patent applications mentioned in this specification are herein incorporated by reference to the same extent as if each individual publication, patent, or patent application was specifically and individually indicated to be incorporated by reference:

Bizzigotti, R. A., “Electromechanical translational apparatus”, U.S. Pat. No. 3,902,085, 1975;

Brisbane, A. D., “Position control device”, U.S. Pat. No. 3,377,489, 1968;

Fujimoto, T., “Piezo-electric actuator and stepping device using same”, U.S. Pat. No. 4,714,855, 1987;

Hara, A., H. Takao, Y. Kunio, and N. Keiji, “Electromechanical translation device comprising an electrostrictive drive of a stacked ceramic capacitor type”, U.S. Pat. No. 4,570,096, 1986;

Hsu, K., and A. Biatter, “Transducer”, U.S. Pat. No. 3,292,019, 1966;

Ishikawa, and Y. Sakitani, “Two-directional piezoelectric driven fine adjustment device”, U.S. Pat. No. 4,163,168, 1979;

Locher, G. L, “Micrometric linear actuator”, U.S. Pat. No. 3,296,467, 1967;

Meisner, J. E. and Teter, J. P, “Piezoelectric/magnetostrictive resonant inchworm motor”, SPIE, Vol. 2190, pp. 520-527, 1994;

Murata, T., “Drive apparatus and motor unit using the same”, U.S. Pat. No. 4,974,077, 1990;

O'Neill, G., “Electromotive actuator”, U.S. Pat. No. 4,219,755, 1980;

Pandel, T. and Garcia E., “Design of a piezoelectric caterpillar motor” Proceedings of the ASME aerospace division, AD-Vol. 52, pp. 627-648, 1996;

Rennex, “Inchworm actuator”, U.S. Patent: 5,3323,942, 1994;

Sakitani, Y., “Stepwise fine adjustment”, U.S. Pat. No. 3,952,215, 1976;

Staufenberg, C. W., Jr., and R.J. Hubbell, “Piezoelectric electromechanical translation apparatus”, U.S. Pat. No. 4,622,483, 1986;

Stibitz, R., “Incremental Feed Mechanisms”, U.S. Pat. No. 3,138,749, 1964; and

Taniguchi, T., “Piezoelectric driving apparatus”, U.S. Pat. No. 4,454,441, 1984.

All of the above-listed publications and patents are incorporated herein by reference in their entirety and for all purposes.

### BRIEF DESCRIPTION OF DRAWINGS

The detailed description of some embodiments of the invention is made below with reference to the accompanying figures, wherein like numerals represent corresponding parts of the figures.

FIG. 1 is a diagram presenting an invented IM1B actuator in a preferred application.

FIG. 5 presents a schematic diagram of an invented IM2R actuator, as the first in a series of steps presented in FIGS. 5 through 12.

FIG. 6 is a diagram presenting a second position in the movement process begun in FIG. 5.

FIG. 7 is a diagram presenting a third position in the movement process begun in FIG. 5.

FIG. 8 is a diagram presenting a fourth position in the movement process begun in FIG. 5.

FIG. 9 is a diagram presenting a fifth position in the movement process begun in FIG. 5.

FIG. 10 is a diagram presenting a sixth position in the movement process begun in FIG. 5.

FIG. 11 is a diagram presenting a seventh position in the movement process begun in FIG. 5.

FIG. 12 is a diagram presenting an eighth position in the movement process begun in FIG. 5.

FIG. 13 presents a schematic diagram of an invented IM2B actuator, as the first in a series of steps presented in FIGS. 13 through 20B.

FIG. 14 presents a schematic diagram showing a second, initialization position for the process of motion begun in FIG. 13.

FIG. 15 is a diagram presenting a third position in the movement process begun in FIG. 13.

FIG. 16 presents a schematic diagram showing a fourth position in the movement process of the IM2B actuator 1300 begun in FIG. 13.

FIG. 17 is a diagram presenting a fifth position in the movement process begun in FIG. 13.

FIG. 18 is a diagram presenting a sixth position in the movement process begun in FIG. 13.

FIG. 19 is a diagram presenting a seventh position in the movement process begun in FIG. 13.

FIG. 20A is a diagram presenting an eighth position in the movement process begun in FIG. 13.

FIG. 20B is a duplicate of FIG. 20A, with additional explanatory annotation added.

FIG. 21A is a schematic diagram presenting a design of dual clamping mechanism suitable for implementation as a component of the IM2B actuator of FIG. 13, as one of the four clamp pairs of FIG. 20B.

FIG. 21B is a schematic diagram presenting additional possible elements of the dual clamping mechanism of FIG. 21A.

FIG. 21C is a diagram of the dual clamping mechanism of FIG. 21A, providing additional annotation regarding the operation of the lever mechanisms of the dual clamping mechanism.

FIG. 22 is a more detailed block diagram of the IM1B actuator of FIG. 1, with the dual clamping mechanism of FIGS. 21A through 21C implemented to provide clamps for practicing the demonstrated methods of FIGS. 5 through 20B.

FIG. 23A is a 3D model of the IM2B actuator of FIGS. 13 through 20B, implementing the dual clamping mechanism of FIGS. 21A through 21C.

FIG. 23B presents a bottom view of the IM2B actuator 3D model of FIG. 23A.

FIG. 23C presents a side profile view of the 3D model of FIGS. 23A and 23B.

FIG. 24A presents a 3D model of the dual clamping mechanism as implemented in the IM2B actuator of FIGS. 23A through 23C.

FIG. 24B is an underside view of the 3D model of the dual clamping mechanism of FIG. 24A.

FIG. 24C is a side view of the 3D model of the dual clamping mechanism of FIG. 24A.

FIG. 24D is a top view of the 3D model of the dual clamping mechanism of FIG. 24A.

### DETAILED DESCRIPTION OF DRAWINGS

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

Throughout this specification, like reference numbers signify the same elements throughout the description of the figures.

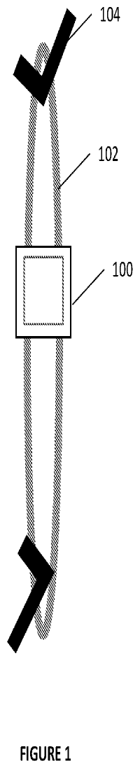

Referring now generally to the Figures and particularly to FIG. 1, FIG. 1 is a diagram presenting an invented IM1B actuator (“the IM1B actuator 100”) in a preferred application wherein the IM1B actuator 100 is positioned to fit around a tendon 102 in two places, and wherein the tendon 102 depends from hooks 104 and the IM1B actuator 100 depends from the tendon 102 and has no fixed position. When the actuator 100 pulls on the tendon 102, the actuator 100 traverses the perimeter of the tendon 102 loop, such that one or both sides of the tendon 102 are shifted and the tendon 102 is placed under tension. Subsequent Figures will expand upon this basic concept, but may present only a portion of this larger picture, such as an actuator (such as the IM1B actuator 100 or a different embodiment of invented actuator) and the sections of one or more tendons 102 immediately adjacent. FIG. 1 offers a broader overview diagram of a simple application, to conceptually support later, more detailed and complicated views and embodiments.

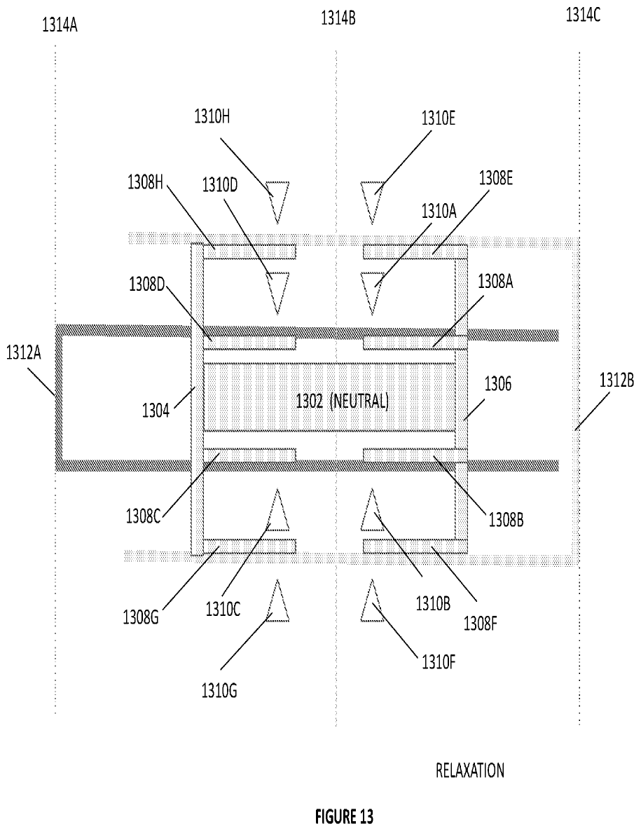

Multiple varieties of invented inchworm actuator are presented herein, and a distinction is made between IM1 and IM2 (an inchworm actuator coupled with a single tendon as opposed to two tendons at once) and also between IM2R and IM2B; both IM2R and IM2B are inchworm actuators coupled to two tendons, but the former's tendons are regular, while the latter's tendons are bridge like. The structural difference between a regular tendon and a bridge like tendon is generally whether the actuator is operating on single lengths of tendon or on loops. The IM2B bridge like variation (loops) is considered to be steadier and more well-balanced, but also more expensive and complex. IM2B's may have up to 400% to 500% contraction rate and generate the force up to 200N (lifting 20 kg or 45 lbs.). The IM2B embodiment, presented at least in FIGS. 13 through 20B and elsewhere, are believed to be the most promising for application to robotics.

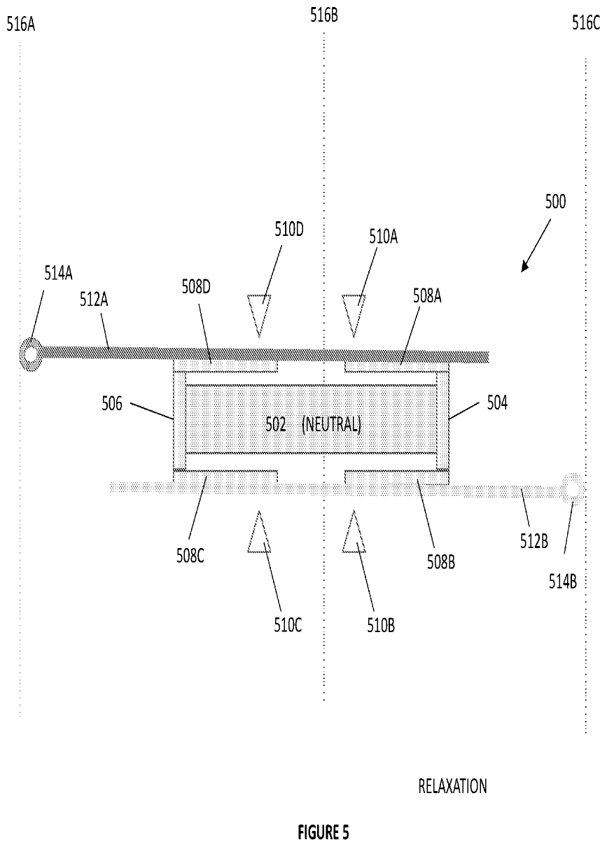

Referring now generally to the Figures and particularly to FIG. 5, FIG. 5 presents a schematic diagram of an invented IM2R actuator (“the IM2R actuator 500”). As this series of diagrams presents a conceptual image, such as representing opening and closing clamping mechanisms with little arrows going up and down, this is not necessarily an image of the IM2R actuator 500, but rather a general representation of mechanics that may be practiced with any such IM2R actuator 500. This first, relaxation position may be the position of the IM2R actuator 500 when unpowered or switched off.

The IM2R actuator 500 consists of a piezoelectric stack 502 (hereinafter “the PZT stack 502”); an IM2R top cap 504; an IM2R bottom cap 506; a set of IM2R side walls 508 including a first IM2R side wall 508A, a second IM2R side wall 508B, a third IM2R side wall 508C, and a fourth IM2R side wall 508D; and a set of IM2R clamps 510 including a first IM2R clamp 510A, a second IM2R clamp 510B, a third IM2R clamp 510C, and a fourth IM2R clamp 510D. It is noted that the IM2R top cap 504, IM2R bottom cap 506, and IM2R side walls 508 may be made of metal, plastic, or a similar such material. The IM2R top cap 504 and IM2R bottom cap 506 are coupled to opposite ends of the PZT stack 502, such that when the PZT stack 502 expands, the distance between the IM2R top cap 504 and the IM2R bottom cap 506 increases, and when the PZT stack 502 contracts, the distance decreases. Additionally, it is noted that the IM2R top cap 504, the first IM2R side wall 508A, and the second IM2R side wall 508B may be formed from the same piece of material (such as but not limited to metal or plastic), rather than consisting of separate pieces coupled together. Additionally, it is noted that the IM2R bottom cap 506, the third IM2R side wall 508C, and the fourth IM2R side wall 508D may be formed from the same piece of material (such as but not limited to metal or plastic), rather than consisting of separate pieces coupled together. The function of the IM2R top cap 504, IM2R bottom cap 506, and IM2R side walls 508 may at least include providing a frame of non-PZT material around the PZT stack 502.

IM2R actuator 500 interacts with two elongate tendons 512 in this diagram, specifically a first elongate tendon 512A and a second elongate tendon 512B. These elongate tendons 512 further include a first elongate tendon eye 514A and a second elongate tendon eye 514B respectively, which may be secured to some structure such as a hook belonging to some object that the elongate tendon 512 is used to pull on. Presented here also to assist with visually presenting changes in position of the elements of FIGS. 5 through 12 are drawn three position lines 516: a left position line 516A, a center position line 516B, and a right position line 516C.

Each of the clamps 510 is positioned and adapted to, when engaged, secure the adjacent elongate tendon 512 and prevent this same elongate tendon 512 from changing position relative to the IM2R actuator 500. The first IM2R clamp 510A and fourth IM2R clamp 510D are adjacent to the first elongate tendon 512A, and restrict or permit the movement of the first elongate tendon 512A. The second IM2R clamp 510B and the third IM2R clamp 510C are adjacent to the second elongate tendon 512B, and restrict or permit the movement of the second elongate tendon 512B.

It is noted that in the schematic diagram of FIGS. 5 through 12, the IM2R PZT stack 500 has three states: neutral, extended, and contracted. The current state of the IM2R PZT stack 500 is labeled and color-coded in each Figure, and will also be mentioned in text.

Further, each of the IM2R clamps 510 as presented in FIGS. 5 through 12 has two states, ON and OFF, wherein ON signifies that the IM2R clamp 510 is currently compressing the adjacent elongate tendon 512 and holding this same elongate tendon 512 in position, and OFF signifies that the IM2R clamp 510 is not currently compressing the adjacent elongate tendon 512 and holding this same elongate tendon 512 in position. In these diagrams, each of the IM2R clamps 510 will be colored black and positioned touching the adjacent elongate tendon 512 (i.e. ‘clamped down’) if ON, and colored white and positioned not touching the adjacent elongate tendon 512 if OFF. It is noted that, in FIG. 5, all four of the IM2R clamps 510 are OFF.

The IM2R PZT stack 502 is made of a piezoelectric material that expands in response to electrical current and contracts when the current is absent, such as but not limited to lead zirconate titanate (PZT), barium titanate, and lead titanate. Gallium nitride and zinc oxide also might be considered, and piezo polymer also may be used instead of PZT stacks. Thus, the motion of the IM2R actuator 500 can be stopped and started by closing and opening of a circuit connecting a power source to the IM2R PZT stack 502.

FIGS. 5 through 12 present this same IM2R actuator 500 proceeding through a sequence of positions to effect motion. As a first position in the presented process of motion, this image corresponds to a situation when both elongate tendons 512 are in a neutral, loose, released position (i.e. neither elongate tendon 512 is being put under tension). The PZT stack 502 is in a neutral state, neither elongated nor contracted.

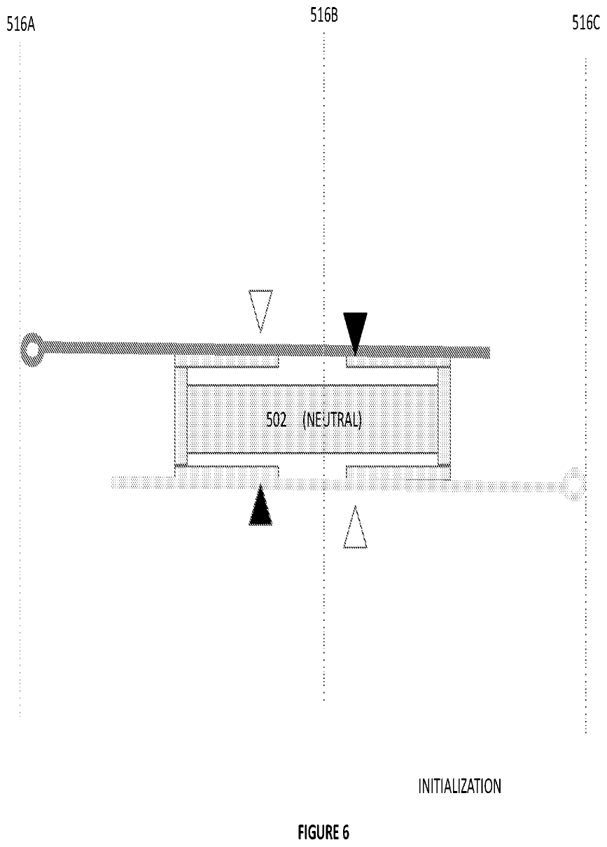

Referring now generally to the Figures and particularly to FIG. 6, FIG. 6 is a diagram presenting a second position in the movement process begun in FIG. 5. The position of FIG. 6 is an initialization, a transition between the complete rest of FIG. 5 and the beginning of a motion cycle. The PZT stack 502 is in a neutral state, neither elongated nor contracted. The first clamp 510A and the third clamp 510C are engaged, respectively grasping the first elongate tendon 512A and the second elongate tendon 512B. This position is preferably suited to the IM2R actuator 500 holding the current position, limiting movement of the IM2R actuator 500 with respect to either elongate tendon 512 and movement of the tendons 512 relative to each other.

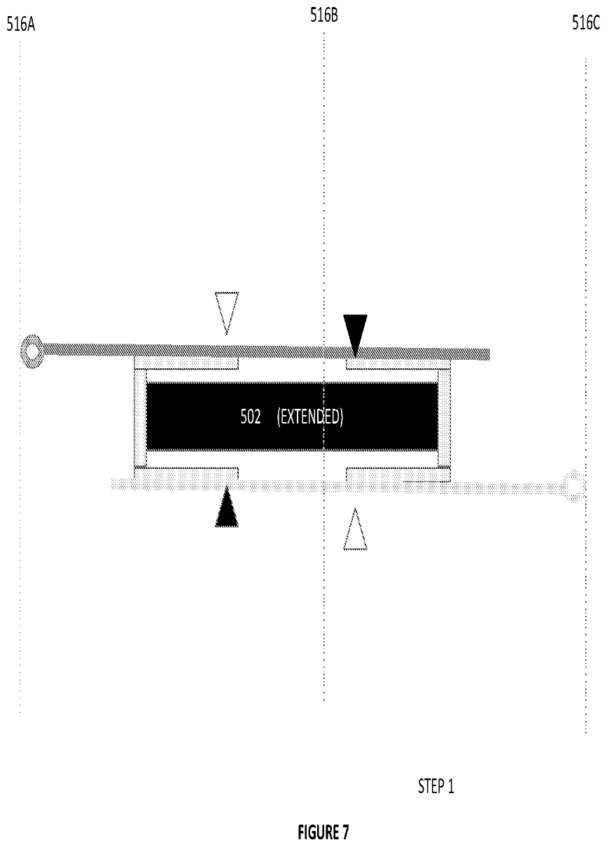

Referring now generally to the Figures and particularly to FIG. 7, FIG. 7 is a diagram presenting a third position in the movement process begun in FIG. 5. The PZT stack 502 shifts to an extended position, with the first clamp 510A and the third clamp 510C still engaged, respectively grasping the first elongate tendon 512A and the second elongate tendon 512B. It is noted that the piezoelectric material of the PZT stack 502 expands physically in volume in response to electric current, guided by the side walls 508 to expand laterally as shown (rather than in all directions).

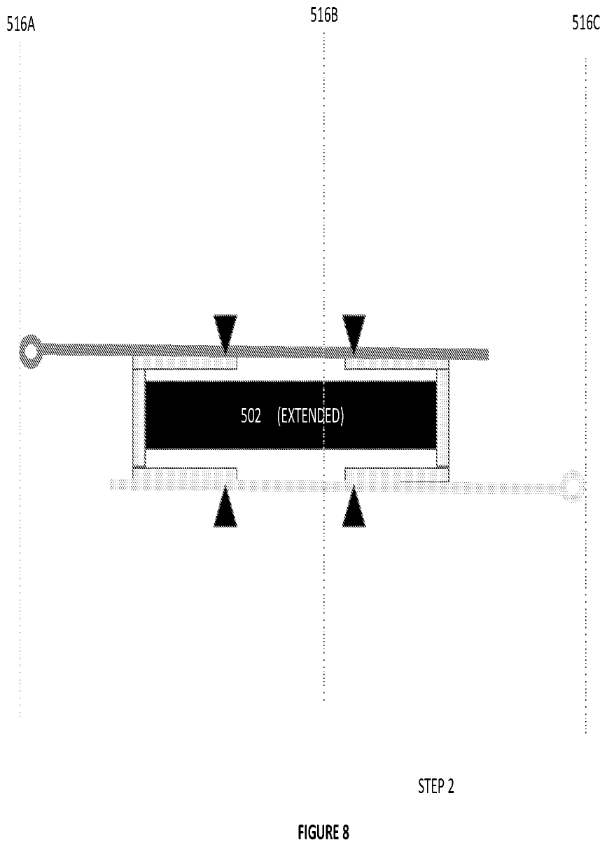

Referring now generally to the Figures and particularly to FIG. 8, FIG. 8 is a diagram presenting a fourth position in the movement process begun in FIG. 5. The PZT stack 502 is in an elongated state. All four of the clamps 510 are engaged, grasping both of the elongate tendons 512 with all of the clamps 510. A position with all IM2R clamps 510 engaged is generally suited to transitioning between engagement patterns of IM2R clamps 510, such that the tension in the elongate tendons 512 is not released while the IM2R clamps 510 shift positions.

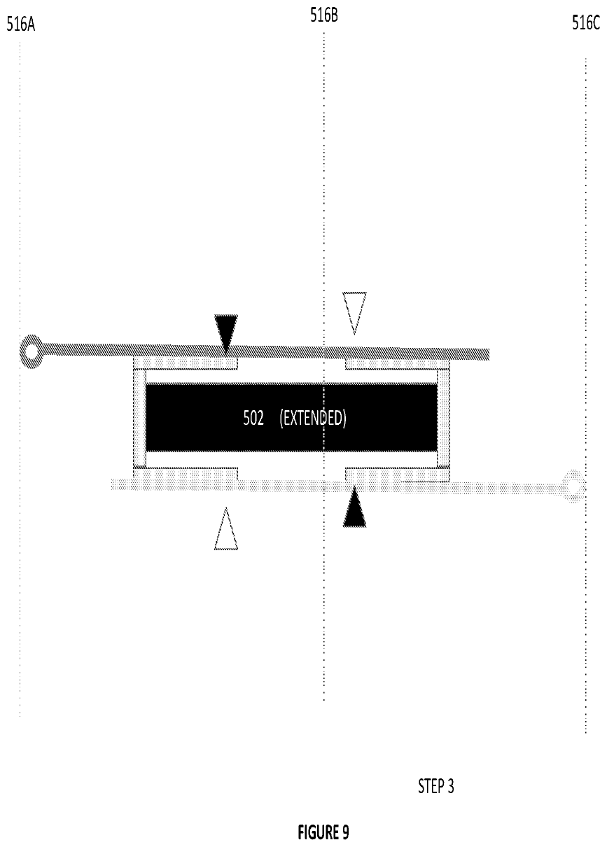

Referring now generally to the Figures and particularly to FIG. 9, FIG. 9 is a diagram presenting a fifth position in the movement process begun in FIG. 5. The IM2R PZT stack 502 is in an extended state. The second clamp 510B and the fourth clamp 510D are engaged, respectively grasping the second elongate tendon 512B and the first elongate tendon 512A. The first clamp 510A and the third clamp 510C are released, such that the tendons 512 have room to move when the PZT stack 502 contracts.

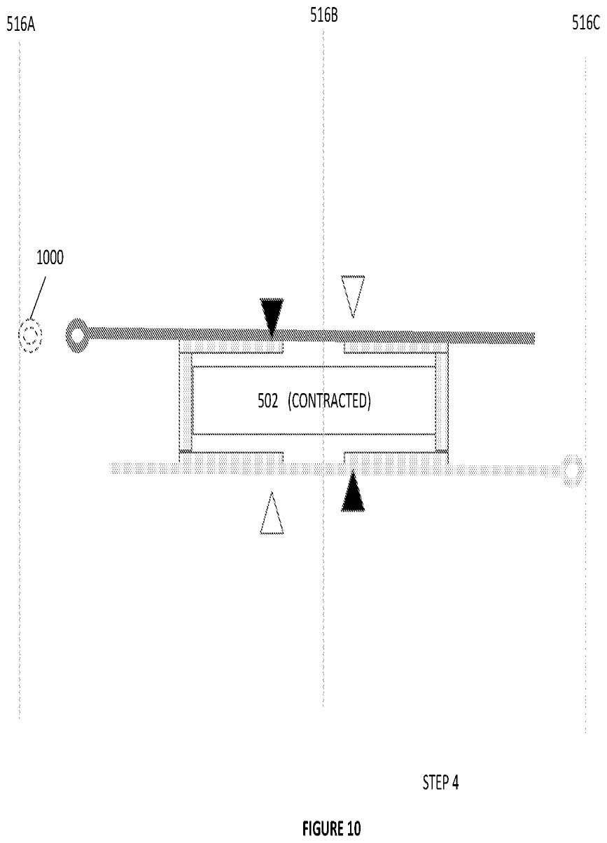

Referring now generally to the Figures and particularly to FIG. 10, FIG. 10 is a diagram presenting a sixth position in the movement process begun in FIG. 5. The PZT stack 502 shifts from the elongated state of FIG. 9 into a compressed state, such that the second clamp 510B and the fourth clamp 510D, respectively grasping the second elongate tendon 512B and the first elongate tendon 512A, are each pulled to a new position. A circle 1000 in FIG. 10 indicates where the first elongate tendon 512A was previously as of FIG. 9, compared to where the first elongate tendon 512A is positioned currently as of FIG. 10.

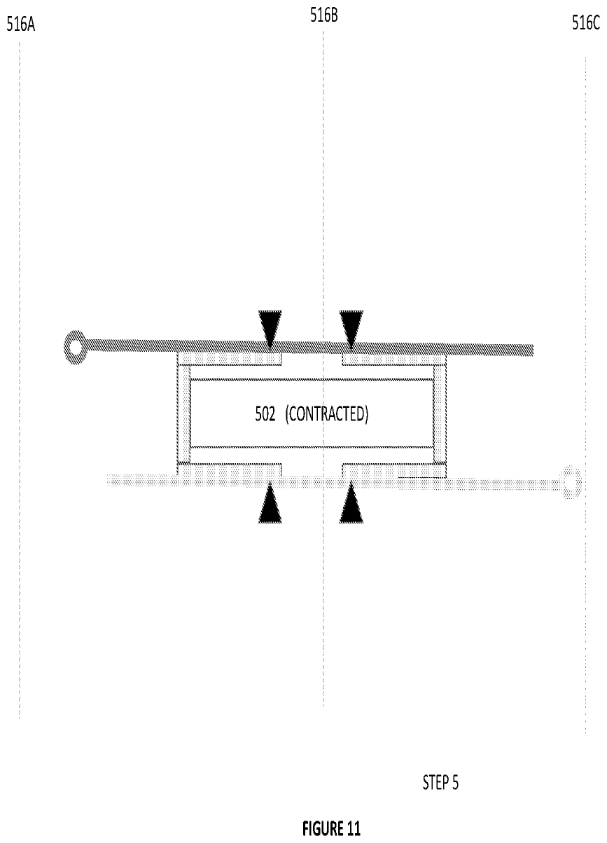

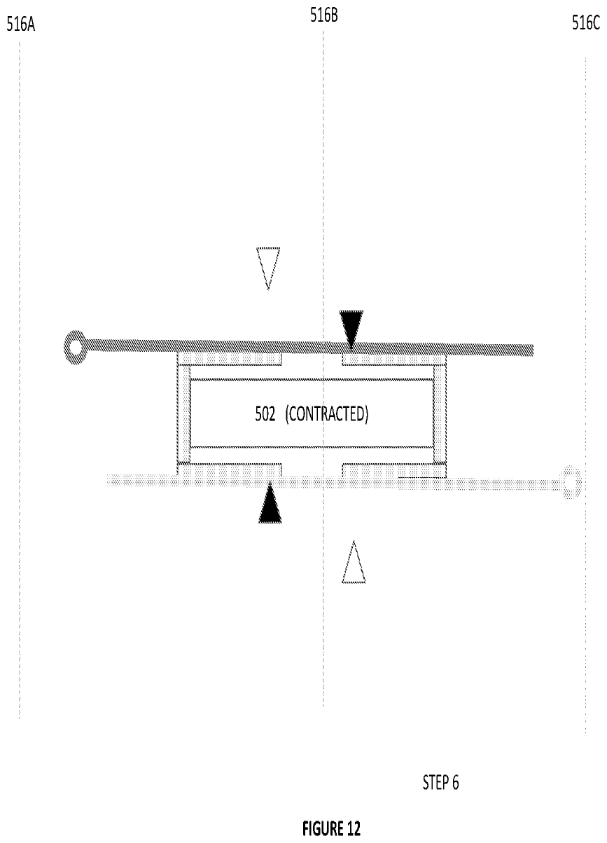

Referring now generally to the Figures and particularly to FIG. 11, FIG. 11 is a diagram presenting a seventh position in the movement process begun in FIG. 5. The IM2R PZT stack 502 remains in a compressed state. All four of the clamps 510 are engaged, grasping both of the tendons 512 with all of the clamps 510. The clamps 510 maintain the current position of the tendons 512 and prevent ‘backsliding’ of the tendons 512, while shifting to the position of FIG. 12.

Referring now generally to the Figures and particularly to FIG. 12, FIG. 12 is a diagram presenting an eighth position in the movement process begun in FIG. 5. The eighth position of FIG. 12 is similar to the initializing position of FIG. 6, with the difference that the PZT stack 502 is already in a compressed position, instead of a neutral position, as the IM2R actuator 500 has already been working. From the position of FIG. 12, the process may continue to the position of FIG. 7, then FIG. 8, and so on to effect further motion. At this point, a full cycle of inching each of the tendons 512 along has been completed, and the IM2R actuator 500 is positioned to begin a next cycle.

It is noted that another way to conceptualize this process is by considering the first clamp 510A and the third clamp 510C to be the ‘front’ two clamps 510, that is the two clamps 510 positioned toward the direction in which each respective elongate tendon 512 is to be moved (i.e. ‘downstream’), and considering the second clamp 510B and the fourth clamp 510D as the ‘back’ two clamps 510, that is the two clamps 510 positioned away from the direction in which the elongate tendon 512 is to be moved (‘upstream’). It is noted that, should one wish to move the tendons 512 in ‘reverse’ relative to this, these designations would likewise reverse. With this pattern observed, one may note that a full cycle goes: clamp front, expand, clamp all, clamp back, contract, clamp all, and back to clamp front. The ‘clamp all’ steps are transitions between the ‘clamp front’ and ‘clamp back’ positions to impede backsliding of the elongate tendons 512, as the elongate tendons 512 are under tension and would snap back if allowed.

Referring now generally to the Figures and particularly to FIG. 13, FIG. 13 presents a schematic diagram of a second embodiment of the invented actuator (“an IM2B actuator 1300”). This first, relaxation position may be the position of the IM2B actuator 1300 when unpowered or switched off.

The IM2B actuator 1300 consists of a piezoelectric stack 1302 (hereinafter “the IM2B PZT stack 1302”); an IM2B top cap 1304; an IM2B bottom cap 1306; a set of IM2B side walls 1308 including a first IM2B side wall 1308A, a second IM2B side wall 1308B, a third IM2B side wall 1308C, a fourth IM2B side wall 1308D, a fifth IM2B side wall 1308E, a sixth IM2B side wall 1308F, a seventh IM2B side wall 1308G, and an eighth IM2B side wall 1308H; and a set of IM2B clamps 1310 including a first IM2B clamp 1310A, a second IM2B clamp 1310B, a third IM2B clamp 1310C, a fourth IM2B clamp 1310D, a fifth IM2B clamp 1310E, a sixth IM2B clamp 1310F, a seventh IM2B clamp 1310G, and an eighth IM2B clamp 1310H. It is noted that the IM2B top cap 1304, IM2B bottom cap 1306, and IM2B side walls 1308 may be made of metal, plastic, or a similar such material. The IM2B top cap 1304 and IM2B bottom cap 1306 are coupled to opposite ends of the IM2B PZT stack 1302, such that when the IM2B PZT stack 1302 expands, the distance between the IM2B top cap 1304 and the IM2B bottom cap 1306 increases, and when the IM2B PZT stack 1302 contracts, the distance decreases. The function of the IM2B top cap 1304, IM2B bottom cap 1306, and IM2B side walls 1308 may at least include providing a frame of non-PZT material around the IM2B PZT stack 1302. Additionally, it is noted that the IM2B top cap 1304 may be part of the same piece of material (such as but not limited to metal or plastic) as any of the adjacent side walls 1308G, 1308C, 1308D, or 1308H, rather than these elements consisting of multiple separate pieces coupled together. Additionally, it is noted that the IM2B bottom cap 1306 may be part of the same piece of material (such as but not limited to metal or plastic) as any of the adjacent side walls 1308E, 1308A, 1308B, or 1308F, rather than these elements consisting of multiple separate pieces coupled together.

The IM2B actuator 1300 interacts with two looped tendons 1312 in this diagram, specifically a first looped tendon 1312A and a second looped tendon 1312B. Presented here also to assist with visually presenting changes in position of the elements of FIGS. 13 through 20B are drawn three position lines 1314: a left position line 1314A, a center position line 1314B, and a right position line 1314C.

Each of the IM2B clamps 1310 is positioned and adapted to, when engaged, secure the adjacent looped tendon 1312 and prevent this same looped tendon 1312 from changing position relative to the IM2B actuator 1300.

The first IM2B clamp 1310A, the second IM2B clamp 1310B, the third IM2B clamp 1310C, and the fourth IM2B clamp 1310D are adjacent to the first looped tendon 1312A, and restrict or permit the movement of the first elongate tendon 1312A. The fifth IM2B clamp 1310E, the sixth IM2B clamp 1310F, the seventh IM2B clamp 1310G, and the eighth IM2B clamp 1310H are adjacent to the second looped tendon 1312B, and restrict or permit the movement of the second looped tendon 1312B.

It is noted that in the schematic diagram of FIGS. 13 through 20B, the IM2B PZT stack 1300 has three states: neutral, extended, and contracted. The current state of the IM2B PZT stack 1300 is labeled and color-coded in each Figure, and will also be mentioned in text.

Further, each of the IM2B clamps 1310 as presented in FIGS. 13 through 20B has two states, ON and OFF, wherein ON signifies that the IM2B clamp 1310 is currently compressing the adjacent looped tendon 1312 and holding this same looped tendon 1312 in position, and OFF signifies that the IM2B clamp 510 is not currently compressing the adjacent looped tendon 1312 and holding this same looped tendon 1312 in position. In these diagrams, each of the IM2B clamps 1310 will be colored black and positioned touching the adjacent looped tendon 1312 (i.e. ‘clamped down’) if ON, and colored white and positioned not touching the adjacent looped tendon 1312 if OFF. It is noted that, in FIG. 13, all eight of the IM2B clamps 1310 are OFF.

It is noted that the elongate tendons 512 of FIGS. 5 through 12 are distinct from the looped tendons 1312 of FIGS. 13 through 20B in that the elongate tendons 512 FIGS. 5 through 12 are formed as straight strands, while the looped tendons 1312 of FIGS. 13 through 20B are closed loops. It is noted that these two separate varieties of tendons are represented herein to present different embodiments of tendon, but these don't correlate to the embodiment of actuator; either kind of actuator may operate either kind of tendon. For instance, the IM2B actuator 1300 might have a straight strand of tendon ‘folded around’ such that all sets of IM2B clamps 1310 are used; as FIGS. 13 through 20B don't have the entire closed loops in view, it's easy to see that the operation of the IM2B actuator 1300 doesn't depend on the tendon loop being closed. Similarly, the IM2R actuator 500 might manipulate looped tendons 1312 instead of straight elongate tendons 512.

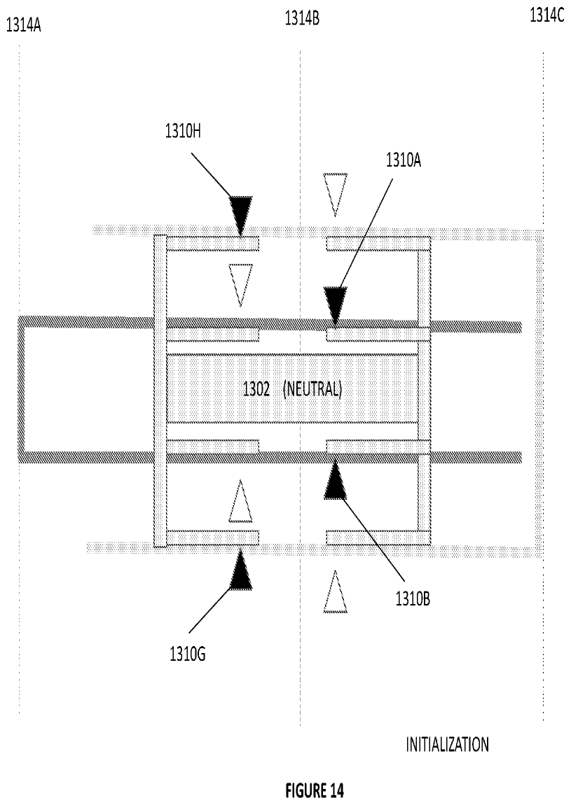

Referring now generally to the Figures and particularly to FIG. 14, FIG. 14 presents a schematic diagram showing a second, initialization position for a cycle of motion of the IM2B actuator 1300. In this position, the IM2B PZT stack 1300 is in neutral state; the first IM2B clamp 1310A, the second IM2B clamp 1310B, the seventh IM2B clamp 1310G, and the eighth IM2B clamp 1310H are all ON, and the remaining IM2B clamps 1310 are OFF. This initialization position, good for holding the current position or preparing for a next movement, corresponds to the initialization state of the IM2R actuator 500 of FIG. 6.

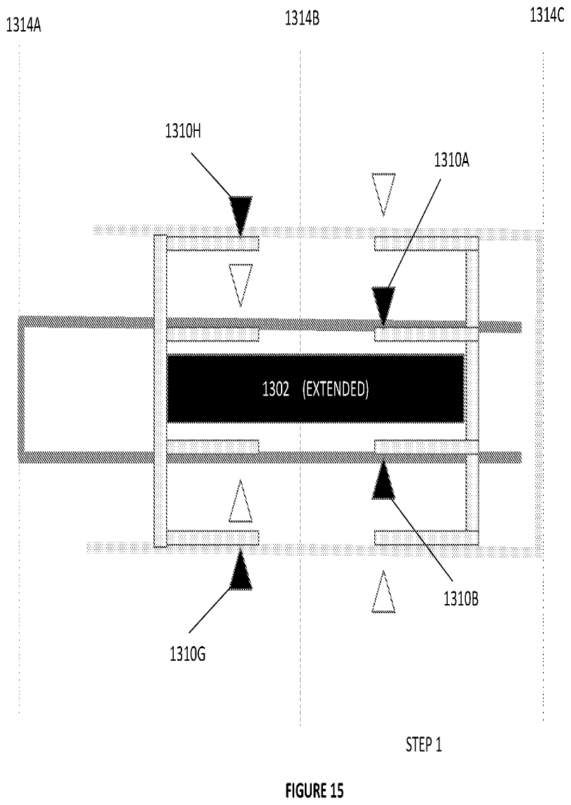

Referring now generally to the Figures and particularly to FIG. 15, FIG. 15 is a diagram presenting a third position in the movement process begun in FIG. 13. The PZT stack 1302 shifts to an extended position. The same set of IM2B clamps remains engaged: namely, the first IM2B clamp 1310A, the second IM2B clamp 1310B, the seventh IM2B clamp 1310G, and the eighth IM2B clamp 1310H. It is noted that the piezoelectric material of the PZT stack 1302 expands physically in volume in response to electric current, guided by the side walls 1308 to expand laterally as shown (rather than in all directions). It is noted that the IM2B actuator 1300 may move in either direction along the tendons 1312, and that in the present instance the IM2B actuator 1302 is moving toward the right position line 1314C. This third position of the IM2B actuator 1300 is analogous to the third position of the IM2R actuator 500 of FIG. 7.

Further, it is noted that in the example of FIGS. 5 through 12, the IM2R actuator 500 moved the elongate tendons 512 to a new position relative to the IM2R actuator (as presented at least in FIG. 10), whereas in the present example of FIGS. 13 through 20B, the IM2B actuator 1300 shifts its own position relative to the looped tendons 1312. This is not correlated to the type of actuator or the type of tendon; these are merely two different available applications. Whether, by pulling on the tendons, an actuator moves the tendon or moves the actuator, will depend on the rest of the structure and what is being pulled against. In one preferred application, tendons may be attached to fixed hooks, such that by pulling on the tendons, the free-hanging actuator repositions itself upon the tendons, like a spider on a web or a bead connecting two strings, and puts tension on the tendons by doing so. In other applications, the actuator may be fixed in place, such as bolted down; in that case, when the actuator pulls, the tendons will do the moving. In other applications, a pull from the actuator may move both the actuator itself and the tendon being pulled.

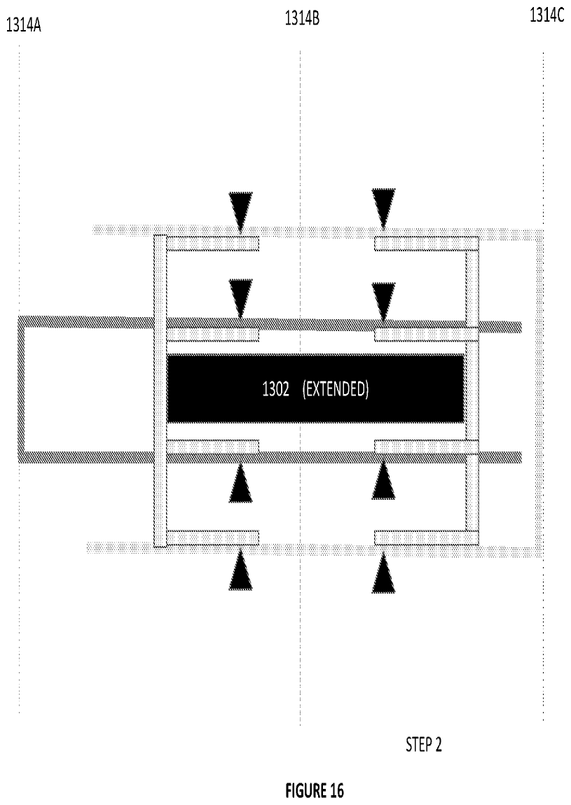

Referring now generally to the Figures and particularly to FIG. 16, FIG. 16 presents a schematic diagram showing a fourth position in the movement process of the IM2B actuator 1300 begun in FIG. 13. In this step, all eight IM2B clamps 1310 are ON. A position with all IM2B clamps 1310 engaged is generally suited to transitioning between engagement patterns of IM2B clamps 1310, such that the tension in the elongate tendons 1312 is not released while the IM2B clamps 1310 shift positions. The IM2B PZT stack 1302 remains in the extended position of FIG. 15. This fourth position of the IM2B actuator 1300 is analogous to the fourth position of the IM2R actuator 500 of FIG. 8.

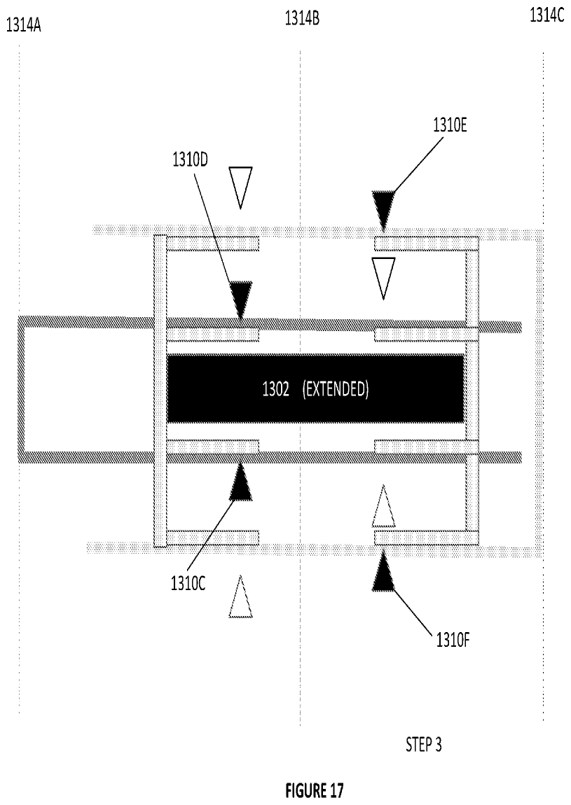

Referring now generally to the Figures and particularly to FIG. 17, FIG. 17 is a diagram presenting a fifth position in the movement process begun in FIG. 13. The IM2B PZT stack 1302 remains in an extended state. The fifth IM2B clamp 1310E, the sixth IM2B clamp 1310F, the third IM2B clamp 1310C, and the fourth IM2B clamp 1310D are engaged, and the other four IM2B clamps 1310 are released. This fifth position of the IM2B actuator 1300 is analogous to the fifth position of the IM2R actuator 500 of FIG. 9.

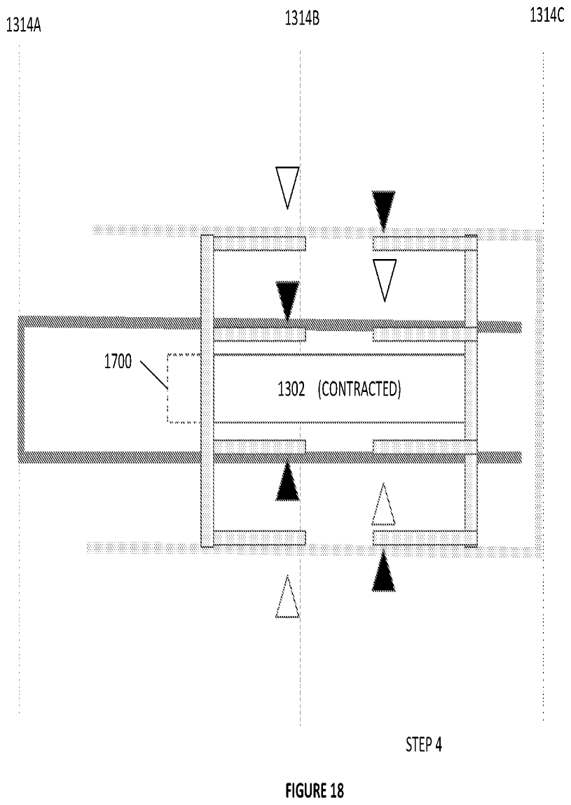

Referring now generally to the Figures and particularly to FIG. 18, FIG. 18 is a diagram presenting a sixth position in the movement process begun in FIG. 13. The IM2B PZT stack 1302 shifts from the extended state of FIG. 17 into a compressed state, such that the IM2B actuator 1300 is pulled to a new position. A line 1700 indicates the prior position of the IM2B PZT stack 1302 as of FIG. 17, compared to the same element's current position. This sixth position of the IM2B actuator 1300 is analogous to the sixth position of the IM2R actuator 500 of FIG. 10.

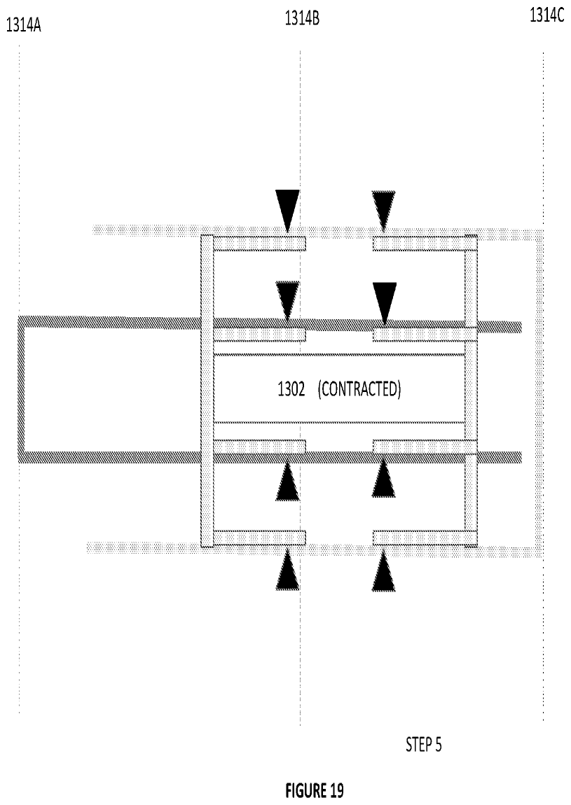

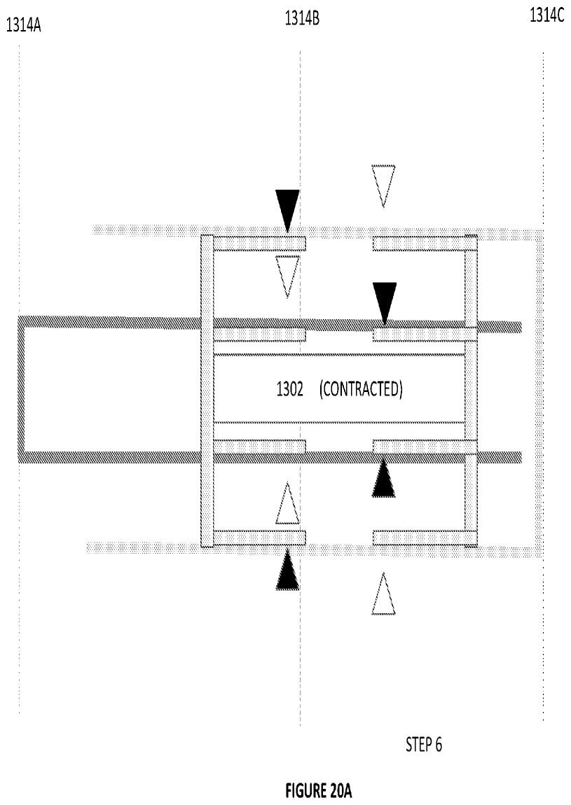

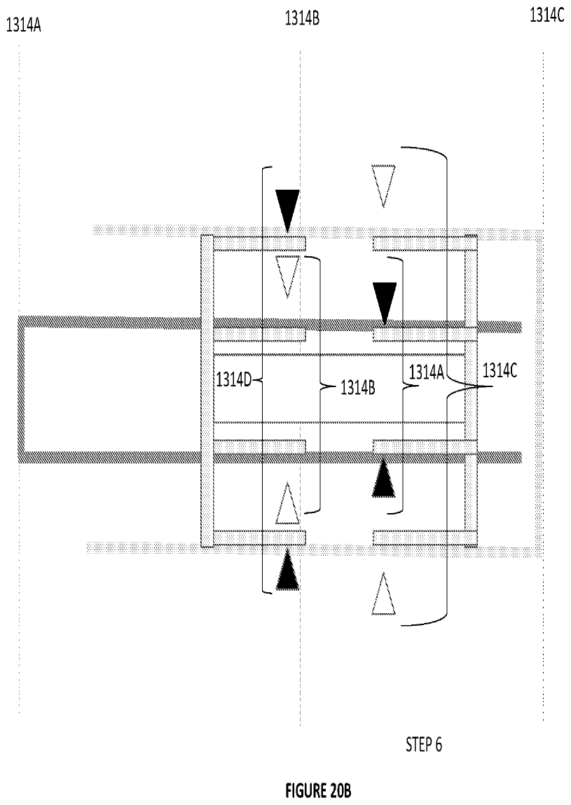

Referring now generally to the Figures and particularly to FIG. 19, FIG. 19 is a diagram presenting a seventh position in the movement process begun in FIG. 13. The IM2B PZT stack 1302 remains in a compressed state. All eight of the clamps 1310 are engaged, grasping both of the tendons 1312 with all of the clamps 1310. The clamps 1310 maintain the current position of the tendons 1312 and prevent ‘backsliding’ of the tendons 1312, while shifting to the position of FIG. 20A. This seventh position of the IM2B actuator 1300 is analogous to the seventh position of the IM2R actuator 500 of FIG. 11.

Referring now generally to the Figures and particularly to FIG. 20A, FIG. 20A is a diagram presenting an eighth position in the movement process begun in FIG. 13. The eighth position of FIG. 20A is similar to the initializing position of FIG. 14, with the difference that the IM2B PZT stack 1302 is already in a compressed position, instead of a neutral position, as the IM2B actuator 1300 has already been working. From the position of FIG. 20A, the process may continue to the position of FIG. 15, then FIG. 16, and so on to effect further motion. At this point, a full cycle of inching each of the tendons 1312 along has been completed, and the IM2B actuator 1300 is positioned to begin a next cycle. This eighth position of the IM2B actuator 1300 is analogous to the eighth position of the IM2R actuator of FIG. 12.

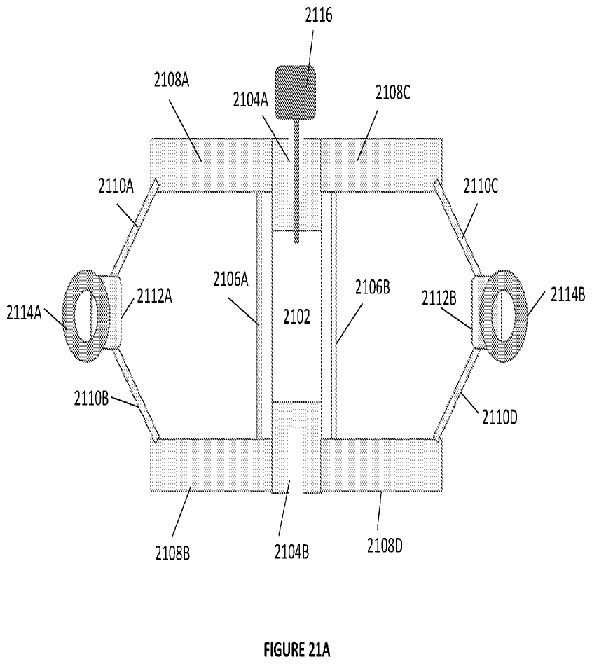

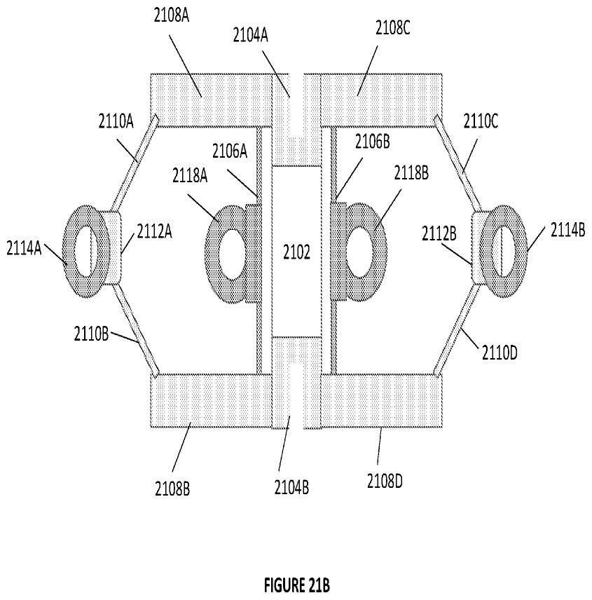

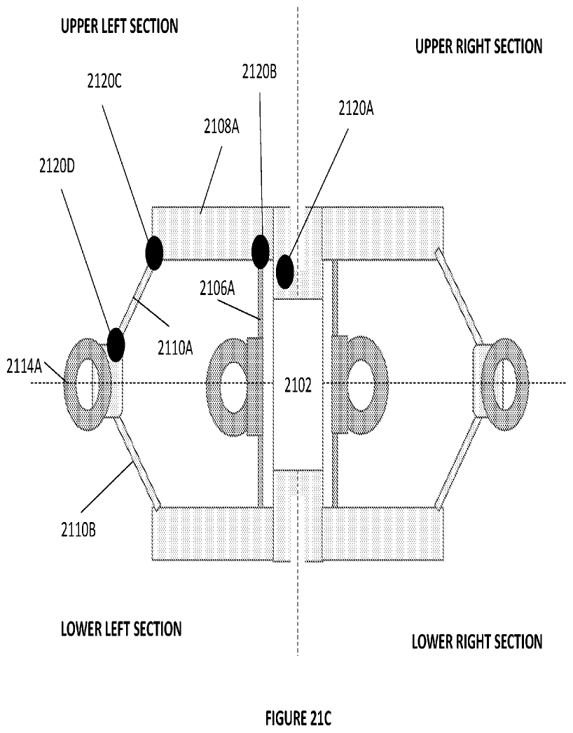

Referring now generally to the Figures and particularly to FIG. 20B, FIG. 20B is a duplicate of FIG. 20A, with additional annotation added. Specifically, the annotation of FIG. 20B comprises four brackets grouping the eight IM2B clamps 1310 into a set of four synchronized clamp pairs 1316 (“the clamp pairs 1316”). The clamp pairs 1316 comprise a first downstream clamp pair 1316A comprising the first clamp 1310A and the second clamp 1310B; a first upstream clamp pair 1316B comprising the third clamp 1310C and the fourth clamp 1310D; a second upstream clamp pair 1316C comprising the fifth clamp 1310E and the sixth clamp 1310F; and a second downstream pair 1316D comprising the seventh clamp 1310G and the eighth clamp 1310H. Viewing the process of FIGS. 13 through 20B as the motion of these four clamp pairs 1316, one may notice that the two individual IM2B clamps 1310 of each clamp pair 1316 are always either both clamped or both released, never out of sync, and that the pattern followed by the clamp pairs 1316 is directly analogous to the cycle performed with single clamps in the process of FIGS. 5 through 12: clamp downstream, extend, clamp all, clamp upstream, contract, clamp all, clamp downstream. Viewing the clamps 1310 as clamp pairs 1316 may be helpful in understanding at least FIGS. 21A and 21B.

For a further practical analogy which may be useful regarding the interactions of the invented actuators and tendons, particularly the looped tendons 1312, one might consider the cord lock on a drawstring, such as one might use to tighten a standard sleeping bag stuff sack. The drawstring traverses the cord lock twice, such that when one presses the button on the cord lock and moves the cord lock along the drawstring, the cord lock ‘traps’ more and more of the slack from the cord behind itself as it is moved, until eventually the cord lock is snug against the opening of the closed stuff sack, and there's a loose loop of cord left dangling on the outside of the cord lock which previously provided the extra slack for the top of the stuff sack to stand open. Similarly, in preferred applications the IM2B actuator 1300 might pull itself along one or both of the looped tendons 1312, leaving a loose loop of tendon 1312 ‘trapped’ behind and thus tightening the remaining length of looped tendon 1312 ahead of itself. One useful way to think of the invented actuators in general, the IM2R actuator 500 or the IM2B actuator 1300, and how these interact with the elongate tendons 512 or the looped tendons 1312, is with the actuator acting as a tightening mechanism, analogous to that cord lock, a slipknot, or any number of other means for tightening a cord, but with the ability to be controlled or programmed to lock, unlock, and reposition themselves instead of being manually pulled on.

Referring now generally to the Figures and particularly to FIG. 21A, FIG. 21A is a schematic diagram presenting a design of dual clamping mechanism 2100 suitable for implementation as a component of the IM2B actuator 1300 as one of the four clamp pairs 1316. The dual clamping mechanism 2100 comprises and includes a clamp piezoelectric stack 2102 (“the clamp PZT stack 2102”), an upper push point 2104A and a lower push point 2104B, a left beam 2106A, a right beam 2106B, a left upper lever 2108A, a left lower lever 2108B, a right upper lever 2108C, a right lower lever 2108D, a left upper arm 2110A, a left lower arm 2110B, a right upper arm 2110C, a right lower arm 2110D, a left pusher 2112A, a right pusher 2112B, a left holder 2114A, and a right holder 2114B.

It is noted that the subjective terms “left”, “right”, “upper” and “lower” are used to describe a mechanism that might be oriented in practically any direction. These terms are used only in the sense of the visual diagram as presented in FIGS. 21A through 21C: “upper” means toward the top of the page, “lower” means toward the bottom of the page, “left” means toward the viewer's left, and “right” means toward the viewer's right. These terms are used solely to distinguish directionally between otherwise symmetrical and identical elements.

In preferred operation, the clamp PZT stack 2102 expands in volume in response to receiving electric current, pushing against the upper push point 2104A, the lower push point 2104B, the left beam 2106A, and the right beam 2106B. When the upper push point 2104A is pushed against by the expanding clamp PZT stack 2102, the upper push point 2104A in turn pushes against the upper left lever 2108A and the upper right lever 2108C, which in turn shift position to press on the upper left arm 2110A and the upper right arm 2110C respectively. When the lower push point 2104B is pushed against by the expanding clamp PZT stack 2102, the lower push point 2104B in turn pushes against the lower left lever 2108B and the lower right lever 2108D, which in turn shift position to press on the lower left arm 2110B and the lower right arm 2110D respectively. Combined pressure from the upper left arm 2110A and the lower left arm 2110B forces the left pusher 2112A outward (toward the left side of the image, in this case). The left holder 2114A is a ring or tube that the looped tendon 1312 being held by this dual clamping mechanism 2100 (not shown) is threaded through, such that the looped tendon 1312 is pushed against the side of the holder 2114A by the left pusher 2112A and thus held in place. Likewise, combined pressure from the upper right arm 2110C and the lower right arm 2110D forces the right pusher 2112B outward (toward the right side of the image, in this case). The right holder 2114B is a ring or tube that the looped tendon 1312 is threaded through, such that the looped tendon 1312 is pushed against the side of the holder 2114B by the right pusher 2112B and thus held in place. It is noted that when the shared clamp PZT stack 2102 is activated (i.e. supplied with electricity), BOTH sides of the dual clamping mechanism 2100 engage; this dual clamping mechanism 2100 is intended for applications wherein the two clamps 1310 are always in the same ON or OFF state, such as one of the clamp pairs 1314 of FIG. 20B. For regulation purposes, the dual clamping mechanism 2100 may also include a screw 2116.

Referring now generally to the Figures and particularly to FIG. 21B, FIG. 21B presents the dual clamping mechanism 2100 of FIG. 21A with additional possible components, namely a left mounting fixture 2118A and a right mounting fixture 2118B for mounting the dual clamping mechanism 2100 to a fixed point, such as upon the IM2B actuator 1300 in the capacity of a clamp pair 1314 of FIG. 20B.

Referring now generally to the Figures and particularly to FIG. 21C, FIG. 21C is a diagram of the dual clamping mechanism 2100 of FIG. 21A and FIG. 21B, providing additional annotation regarding the operation of the lever mechanisms of the dual clamping mechanism 2100. The annotation provided consists of a set of four dots 2120, namely a first dot 2120A, a second dot 2120B, a third dot 2120C, and a fourth dot 2120D. It is emphasized that the dots 2120 represent physical points on the dual clamping mechanism 2100, not mechanical elements thereof. The annotation provided further consists of dotted lines dividing the dual clamping mechanism 2100 into quadrants along lines of horizontal and vertical symmetry. It is understood that, while these dots and this description describe only the movement of the upper left section of the dual clamping mechanism 2100 as labeled, this same mechanical process is simultaneously occurring in each of the four sections respectively, as the expansion of the clamp PZT stack 2102 is the driving force moving the pieces of all four sections, not just the one currently being described. Anything stated herein regarding the movement of the upper left section, and utilizing the illustration of the dots 2120 positioned on the upper left section, should be understood as applying to the other three sections also, just mirrored horizontally for the upper right section, mirrored vertically for the lower left section, and mirrored horizontally and vertically for the lower right section. It is understood that, while the symmetry of several mechanical aspects is part of the design of this element, incidental features, such as the screw 2116, the mounting fixtures 2118, or other mounting hardware or anything else that may be coupled onto the dual clamping mechanism 2100, need not adhere to the same symmetry.

In preferred operation, when the clamp PZT stack 2102 is extending, the position of the first dot 2120A is moving upward. The point indicated by the second dot 2120B does not move vertically, however, due to the positioning of the left beam 2106A. Therefore, the second dot 2120B indicates a pivot point; as the first dot 2120A is pushed upward, the upper left lever 2108A is displaced, and the point indicated by the third dot 2120C is pushed downward and slightly to the left, against the end of the upper left arm 2110A, but the left holder 2114A cannot displace downward at least because the lower left arm 2110B is exerting equal force upward and leftward as a result of the same process happening simultaneously with the lower left section that is being described regarding the upper left section. Therefore, the leftward force exerted on the left pusher 2112A is at a much longer displacement, making elegant and economical use of the power expended running the clamp PZT stack 2102. Everything just stated regarding the left side of the dual clamping mechanism 2100 applies equally to the right side of the dual clamping mechanism 2100, such that the right pusher 2112B is being pushed rightward simultaneously with the left pusher 2112A being pushed leftward, thus engaging two clamps simultaneously using a single PZT-stack-powered mechanism.

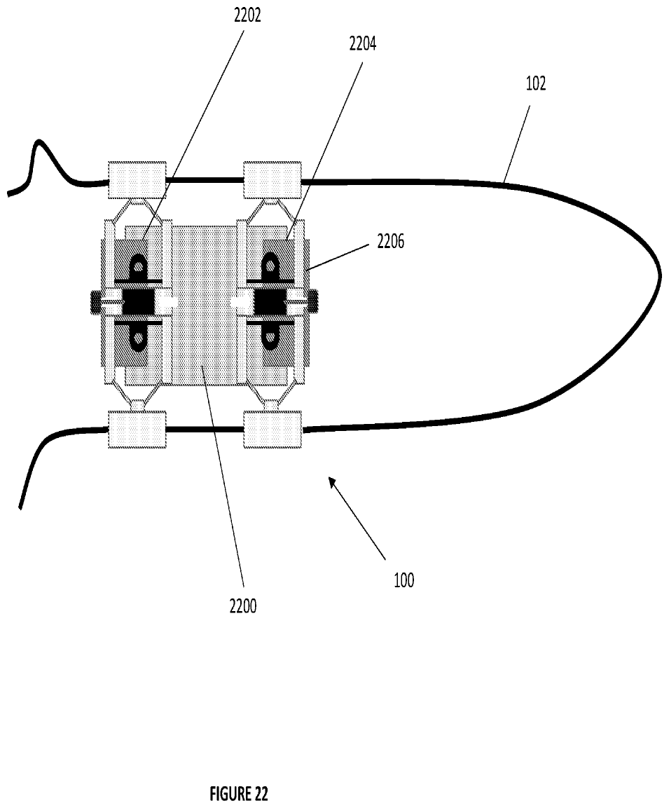

Referring now generally to the Figures and particularly to FIG. 22, FIG. 22 is a more detailed block diagram of the IM1B actuator 100 of FIG. 1, with the dual clamping mechanism 2100 of FIGS. 21A through 21C implemented to provide clamps 1310 for practicing the demonstrated methods of FIGS. 5 through 20B with two sections of a single tendon 102, in this instance, instead of two. The IM1B actuator 100 as presented here includes at least an IM1B PZT stack 2200, a first dual clamp 2202 comprising an instance of the dual clamping mechanism 2100, a second dual clamp 2204 comprising an instance of the dual clamping mechanism 2100, and whatever coupling element 2206 is considered suitable for functionally coupling the first dual clamp 2202 and second dual clamp 2204 onto the IM1B PZT stack 2200, such as but not limited to bolts, soldering, a frame, connecting electrical wires, or similar. The coupling element 2206 is not presented in this image, but can be presumed to be present, such that the first dual clamp 2202 and the second dual clamp 2204 are functionally coupled to the IM1B PZT stack 2200 to build the IM1B actuator 100.

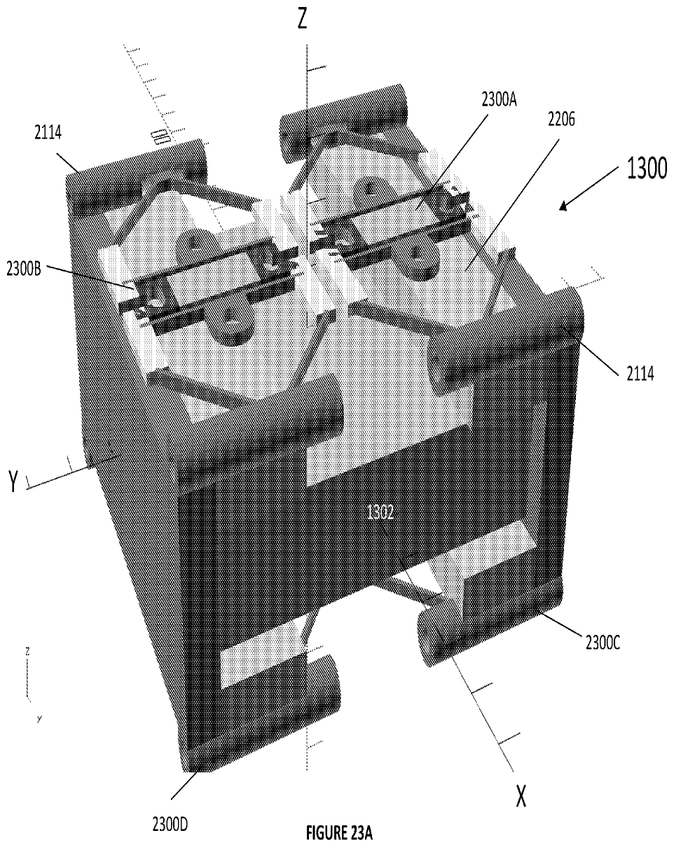

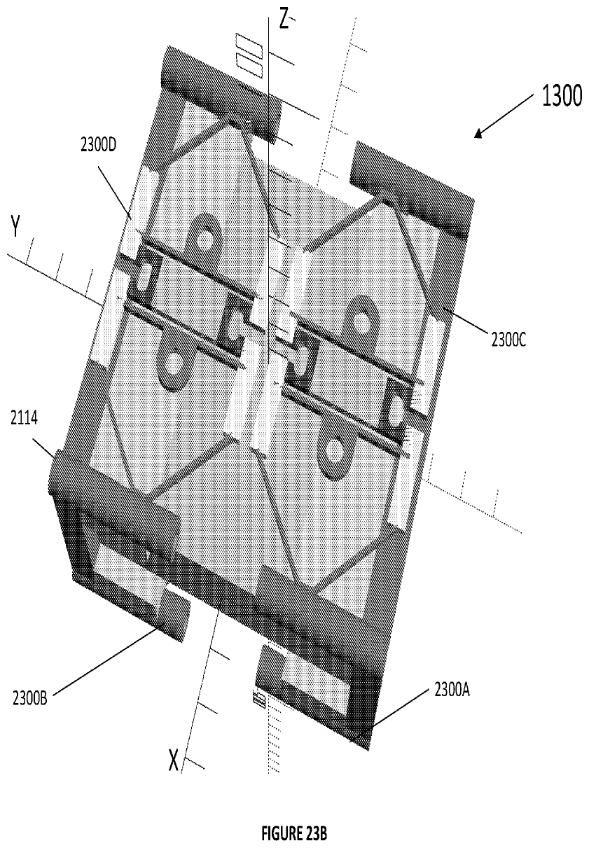

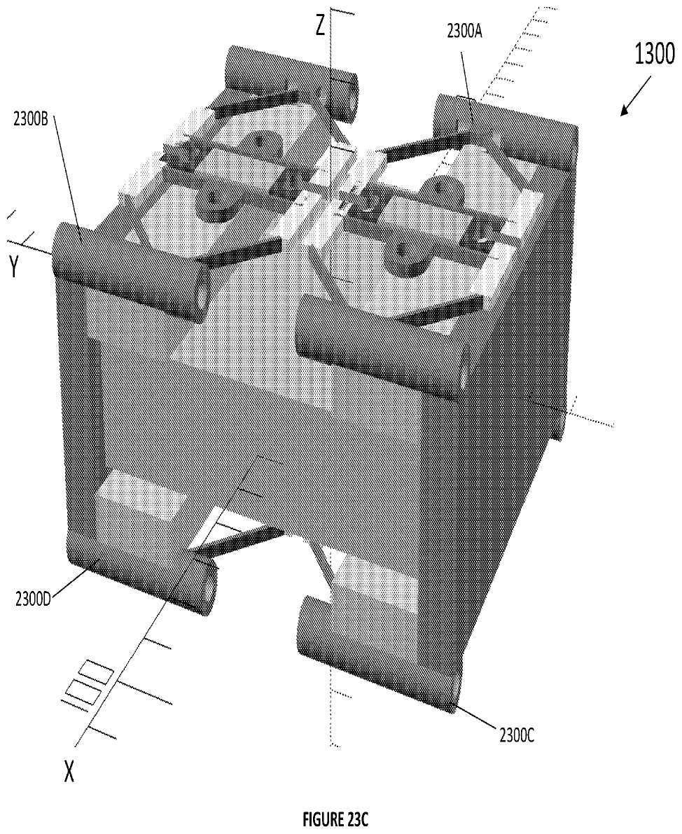

Referring now generally to the Figures and particularly to FIG. 23A, FIG. 23A is a 3D model of the IM2B actuator 1300 of FIGS. 13 through 20B, implementing the dual clamping mechanism 2100 of FIGS. 21A through 21C as the clamps 1310. It is noted that other mechanisms besides clamps may be implemented here to provide the same or equivalent function. The IM2B actuator 1300 has four dual clamps 2300, comprising a first dual clamp 2300A, a second dual clamp 2300B, a third dual clamp 2300C, and a fourth dual clamp 2300D. Each of these dual clamps 2300 may be an instance of the dual clamp mechanism 2100 which functions as one of the clamp pairs 1314 of the IM2B actuator 1300. Presented additionally here are X, Y, and Z axes, wherein the Y axis runs parallel to the length of one or more tendons such as elongate tendons 512 or looped tendons 1312, is the axis along which the PZT stack 1302 expands and contracts, and is the axis along which the IM2B actuator 1300 changes position; the X axis is the axis along which the force of the dual clamps 2300 is exerted (‘left-to-right’ in FIGS. 21A through 21C); the Z axis runs parallel to the surfaces of the IM2B top cap 1304 and IM2B bottom cap 1306; and each axis is orthogonal to the other two axes. One or more tendons such as elongate tendons 512 or looped tendons 1312 are not presented in this Figure, but it is understood that the tendons are run through the holders 2114 of the dual clamping mechanisms 2100. The ‘tube’ shape of these elements may help at least to keep the tendons such as elongate tendons 512 or looped tendons 1312 in alignment, and position these to be held in place by the dual clamps 2300 as discussed in FIGS. 21A through 21C.

Referring now generally to the Figures and particularly to FIG. 23B, FIG. 23B presents a bottom view of the IM2B actuator 1300 3D model of FIG. 23A. Presented here more visibly are the other two dual clamps, the third dual clamp 2300C and the fourth dual clamp 2300D.

Referring now generally to the Figures and particularly to FIG. 23C, FIG. 23C presents a side profile view of the 3D model of FIGS. 23A and 23B. Just like the IM2B actuator 1300 of FIGS. 13 through 20B, this mechanism has eight clamp pairs 1314, each of these controlled by one of the four dual clamps 2300. Presenting this 3D model, rather than a ‘flat’ two-dimensional diagram, allows for a better understanding of how multiple tendons such as elongate tendons 512 or looped tendons 1312 can be handled in separate ‘lanes’ with minimal chance of tangling or overlapping.

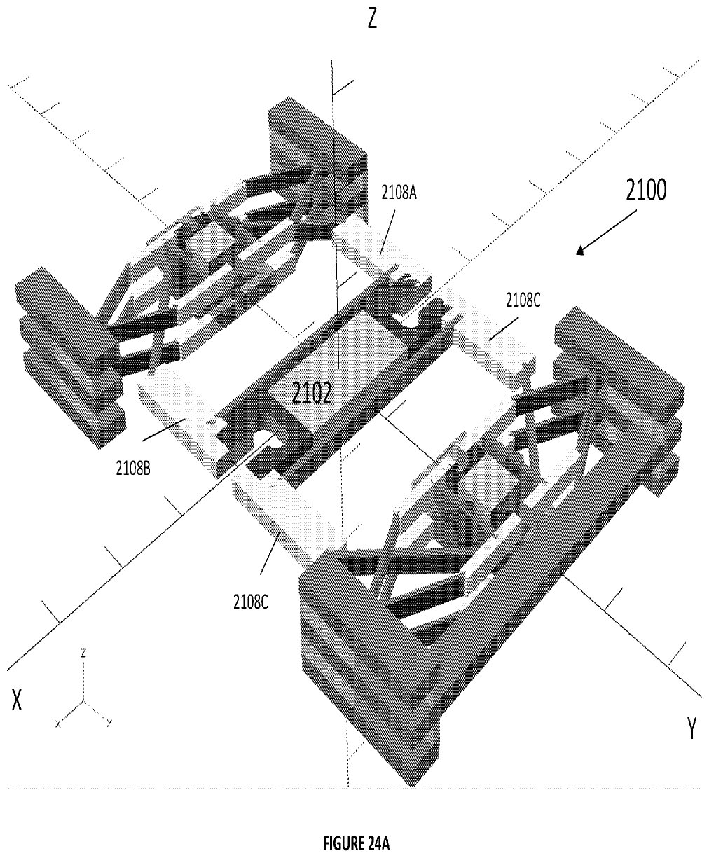

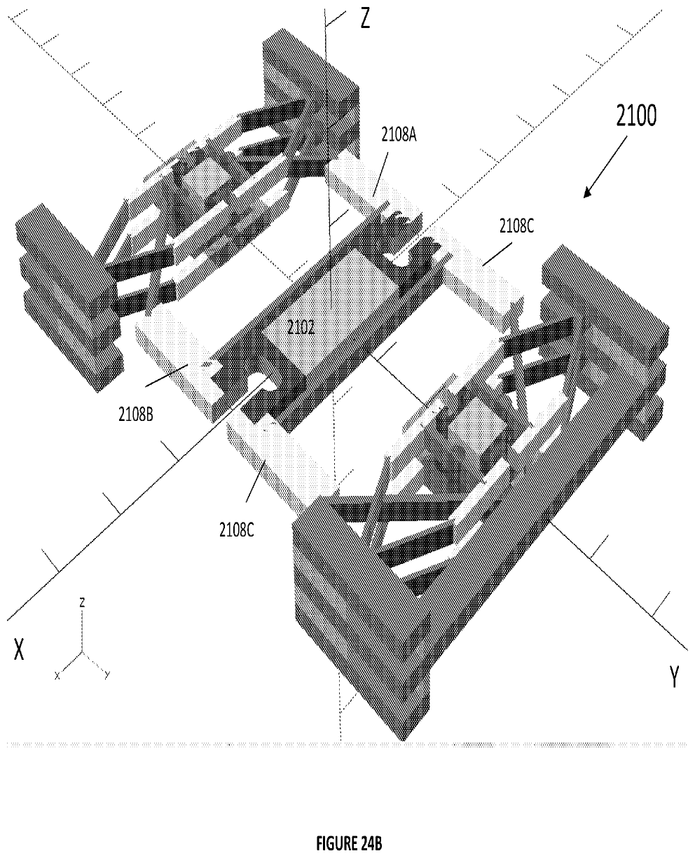

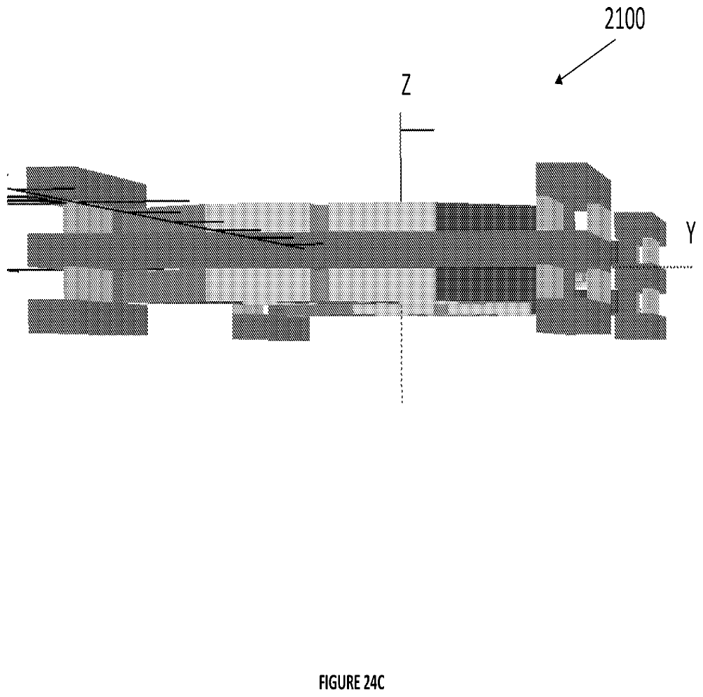

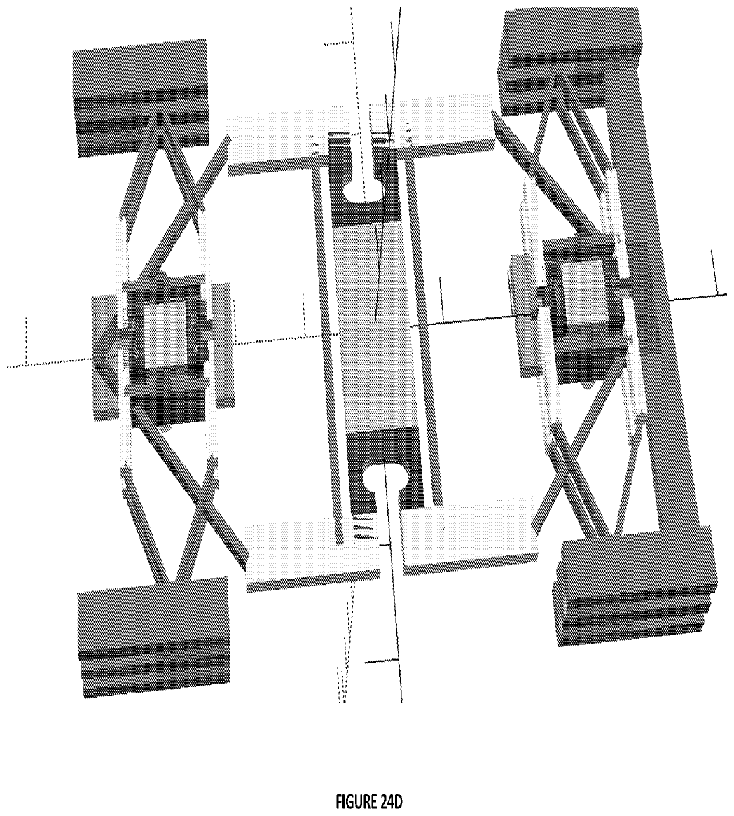

Referring now generally to the Figures and particularly to FIG. 24A, FIG. 24A presents a 3D model of the dual clamping mechanism 2100 as implemented in the IM2B actuator 1300 of FIGS. 23A through 23C. Further explanation regarding the dual clamping mechanism 2100 may be found at least at FIGS. 21A through 21C.

Referring now generally to the Figures and particularly to FIG. 24B, FIG. 24B is an underside view of the 3D model of the dual clamping mechanism 2100 of FIG. 24A. Further explanation regarding the dual clamping mechanism 2100 may be found at least at FIGS. 21A through 21C.

Referring now generally to the Figures and particularly to FIG. 24C, FIG. 24C is a side view of the 3D model of the dual clamping mechanism 2100 of FIG. 24A. Further explanation regarding the dual clamping mechanism 2100 may be found at least at FIGS. 21A through 21C.

Referring now generally to the Figures and particularly to FIG. 24D, FIG. 24D is a top view of the 3D model of the dual clamping mechanism 2100 of FIG. 24A. Further explanation regarding the dual clamping mechanism 2100 may be found at least at FIGS. 21A through 21C.

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

I claim:

1. An inchworm actuator comprising a piezoelectric stack coupled to a first clamp pair.

2. A method for tightening an elastic cord with the inchworm actuator of claim 1, the method comprising controlling the actuator to move and hold a length of the elastic cord behind itself.
